(19) United States
(12) Patent Application Publication
(10) Pub. No.: US 2026/0080598 A1
(43) Pub. Date: Mar. 19, 2026

(54) ANIMATABLE FACIAL IMAGE GENERATION WITH FACIAL ACTION CODING SYSTEM

(71) Applicant: ADOBE INC., SAN JOSE, CA (US)

(72) Inventors: Jun Saito, Seattle, WA (US); Cameron Younger Smith, Santa Cruz, CA (US)

(21) Appl. No.: 18/887,833

(22) Filed: Sep. 17, 2024

(51) Int. Cl. G06T 13/40; G06T 17/00; G06V 40/16

(52) U.S. Cl. CPC G06T 13/40; G06T 17/00; G06V 40/168; G06V 40/174

(57) ABSTRACT

A method, apparatus, non-transitory computer readable medium, and system for image processing include obtaining an expression input indicating a facial expression, generating a guidance feature based on the expression input, where the guidance feature comprises a facial action coding system (FACS) representation of the facial expression, and generating a synthetic image based on the guidance feature, where the synthetic image depicts the facial expression

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on an input.

In some cases, image generation includes the use of a machine learning model to generate a synthetic image based on a dataset. For example, the machine learning model is trained to generate a synthetic image depicting a face. In some cases, an expression of the face depicted in the synthetic image is modified based on a parameter.

### SUMMARY

Aspects of the present disclosure provide a method and system for facial image generation. In one aspect, the system receives an input image depicting a person having a facial expression to generate a synthetic image depicting a different person having the same facial expression. According to some aspects, the system includes an image generation model trained to receive a facial action coding system (FACS) representation of the facial expression as a guidance to generate a synthetic image. The image generation model is conditioned based on the FACS representation. The FACS representation includes an action unit that encodes the visual appearance of the facial expression.

A method, apparatus, non-transitory computer readable medium, and system for image processing include obtaining an identity input (i.e., a face identifying input) and an expression input indicating a facial expression; generating a guidance feature based on the expression input, wherein the guidance feature comprises a facial action encoding of the facial expression; and generating, using an image generation model, a synthetic image based on the face identifying input and the guidance feature, wherein the synthetic image depicts a face corresponding to the face identifying input and having the facial expression.

A method, apparatus, non-transitory computer readable medium, and system for image processing include obtaining training data including a ground-truth image depicting a face with a facial expression and a facial action encoding of the facial expression; and training, using the training data, an image generation model to generate a synthetic image depicting the facial expression based on the facial action encoding.

An apparatus and system for image processing include at least one processor, at least one memory storing instructions executable by the at least one processor, an expression component comprising parameters stored in the at least one memory and configured to generate a guidance feature based on an expression input indicating a facial expression, wherein the guidance feature comprises a facial action encoding of the facial expression; and an image generation model comprising parameters stored in the at least one memory and trained to generate a synthetic image based on a face identifying input and the guidance feature, wherein the synthetic image depicts a face based on the face identifying input with the facial expression from the expression input.

### BRIEF DESCRIPTION OF THE DRAWINGS

FIG. 1 shows an example of an image processing system according to aspects of the present disclosure.

FIG. 2 shows an example of a method for facial generation with expression editing according to aspects of the present disclosure.

FIG. 3 shows an example of a user interface for facial generation according to aspects of the present disclosure.

FIG. 4 shows an example of a method for generating a synthetic image based on an expression input according to aspects of the present disclosure.

FIG. 5 shows an example of an image processing apparatus according to aspects of the present disclosure.

FIG. 6 shows an example of a machine learning model according to aspects of the present disclosure.

FIG. 7 shows an example of a Co-Modulated Generative Adversarial Network (CoModGAN) according to aspects of the present disclosure.

FIG. 8 shows an example of an image generation model according to aspects of the present disclosure.

FIG. 9 shows examples of an expression input according to aspects of the present disclosure.

FIG. 10 shows an example of a method for image processing according to aspects of the present disclosure.

FIG. 11 shows an example of a computing device according to aspects of the present disclosure.

### DETAILED DESCRIPTION

The following relates to image generation using machine learning. Aspects of the disclosure relate to facial image generation. In one aspect, an image generation model receives an expression input (e.g., a text input or an image depicting a person with a target facial expression). The expression input is converted to a facial action coding system (FACS) representation of the facial expression, and the model takes the FACS representation as input and generates a synthetic image with the target expression.

Facial image generation is a subfield of image generation. Images of huma faces can be generated using computer algorithms, e.g., using deep learning techniques. Image generation models include generative adversarial networks (GANs), variational autoencoders (VAEs), or and diffusion models. In some cases, image generation models are trained to generate facial images with various expressions. However, controlling the generation of such images so that they accurately depict facial expressions is challenging

For example, some image generation models use a face mesh to generate and manipulate the facial expressions of a person depicted in an image. A face mesh is a three-dimensional (3D) representation of a huma face including vertices, edges, and faces. Each vertex represents a point in the 3D space, the edges connect pairs of vertices, and the faces represent the surface of the mesh. In some cases, the facial expression of a person to be generated in the output image can be modified or adjusted by manipulating the vertices, edges, and/or faces. However, in some cases, the conventional model may be unable to determine the number of vertices, edges, and faces to represent the huma face depicted in the image.

In another example, some image generation models use landmarks to label key points that correspond to distinctive facial features such as eyebrows, eyes, nose, mouth, and chin. However, the resulting facial expression generation of the output image is heavily dependent on how the landmarks are labeled in the input image. In addition, by using facial landmarks, the conventional image generation model entangles the facial expression with the identity information of the person depicted in the input image. As a result, the target expression may not be achieved in a way that is consistent with the identity of the face.

Accordingly, the embodiments of the disclosure improve on conventional image generation models by generating facial expressions more accurately. In some cases, expressions can be generated while maintaining the identity of a person in a reference image. Embodiments of the disclosure achieve this improved accuracy by using an image generation model that is trained to generate a synthetic image based on a FACS representation of an expression. FACS representations include a more accurate representation of facial expressions than a face mesh or facial landmarks. Thus, a model that takes the FACS representation can generate a target output that reflects the target expression and the target facial identity.

In one aspect, an expression component is trained to generate a guidance feature based on a FACS representation of the facial expression. The guidance feature is used to guide the image generation process of the image generation model. By using the FACS representation, the image generation model is able to disentangle the identity information from the facial expression. For example, the FACS representation includes information about the facial expression of the input image and removes the identity information from the input image.

According to some aspects, the guidance feature includes an identity code that contains identity information of a person different from the person in the input image. By using the identity code to condition the image generation process, the machine learning model is able to disentangle the identity and facial expression. Accordingly, the image generation model generates the synthetic image depicting a person having a different identity from the person depicted in the input image while maintaining the same facial expression.

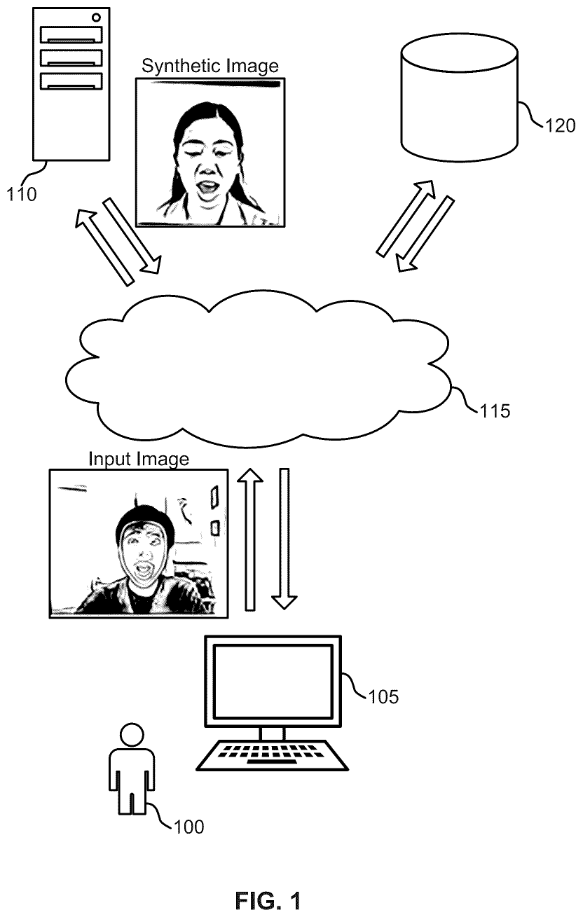

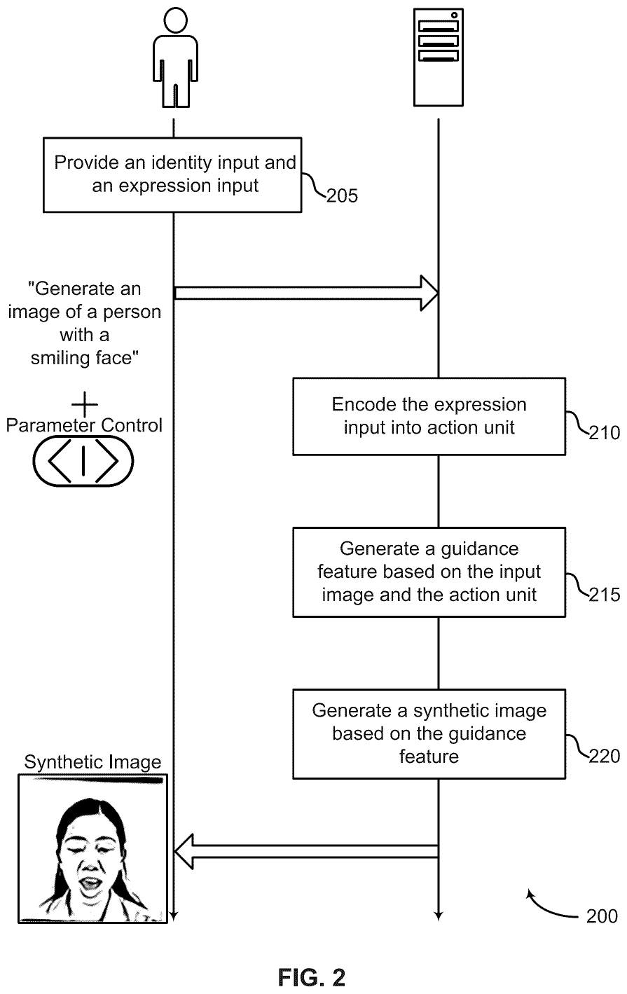

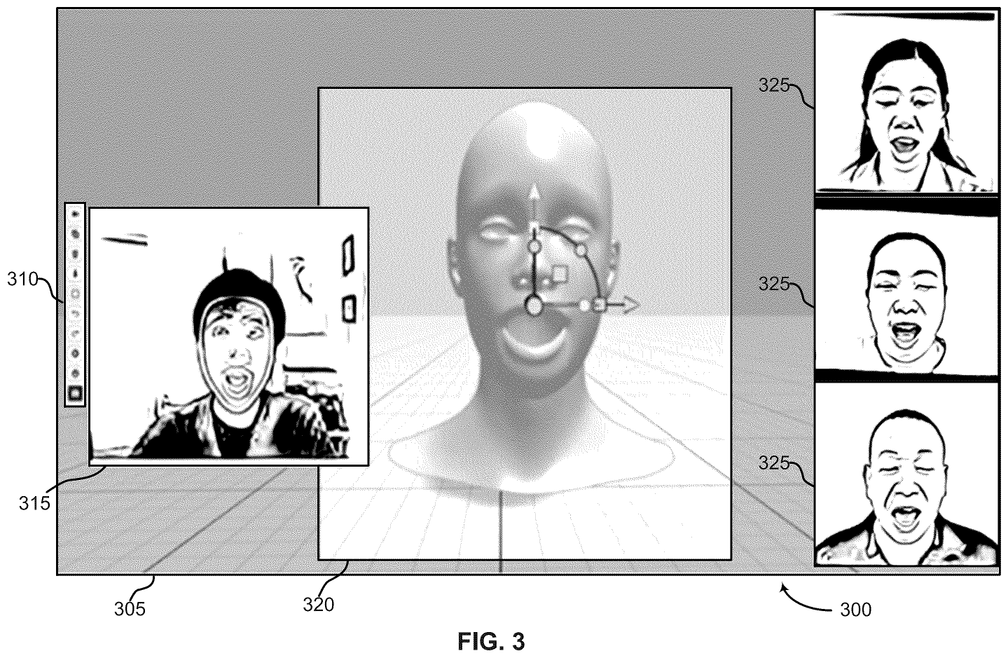

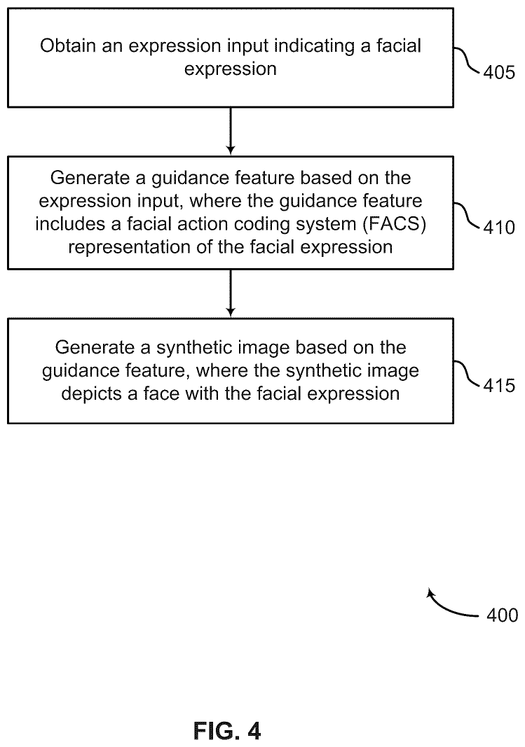

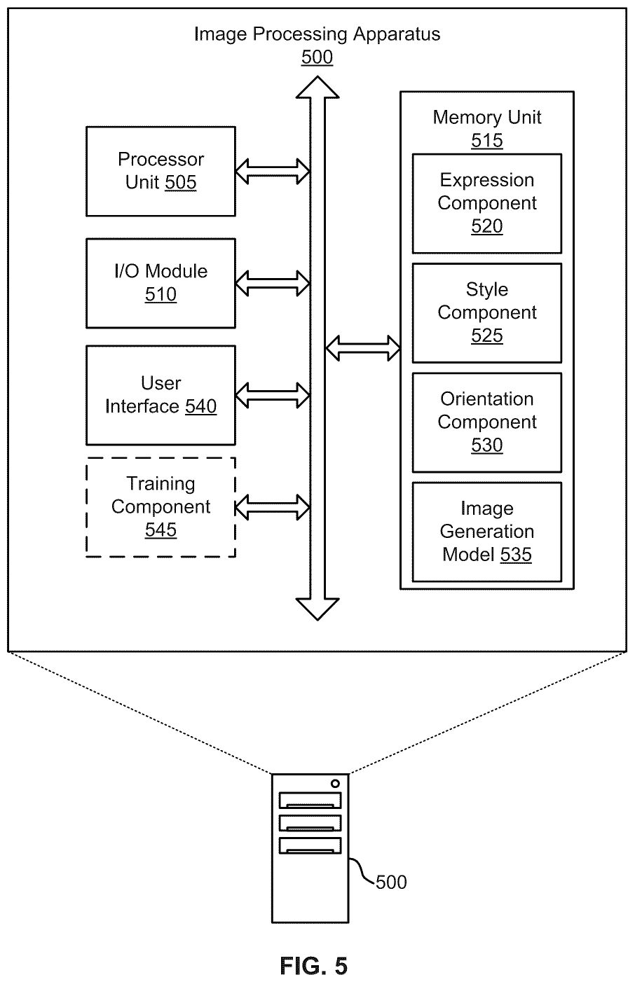

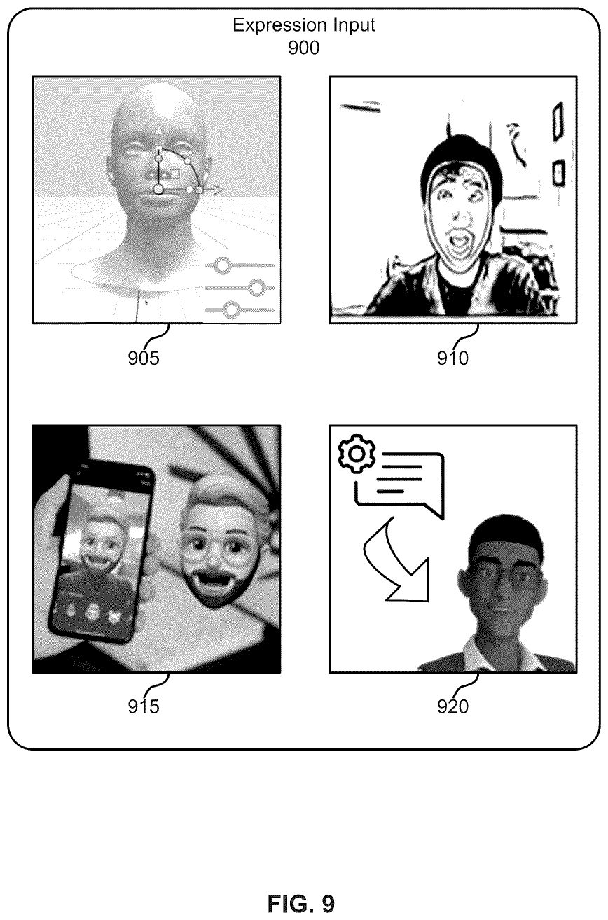

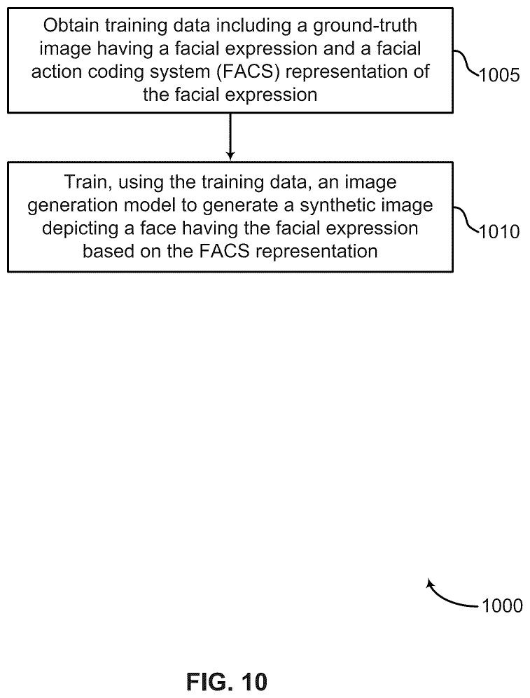

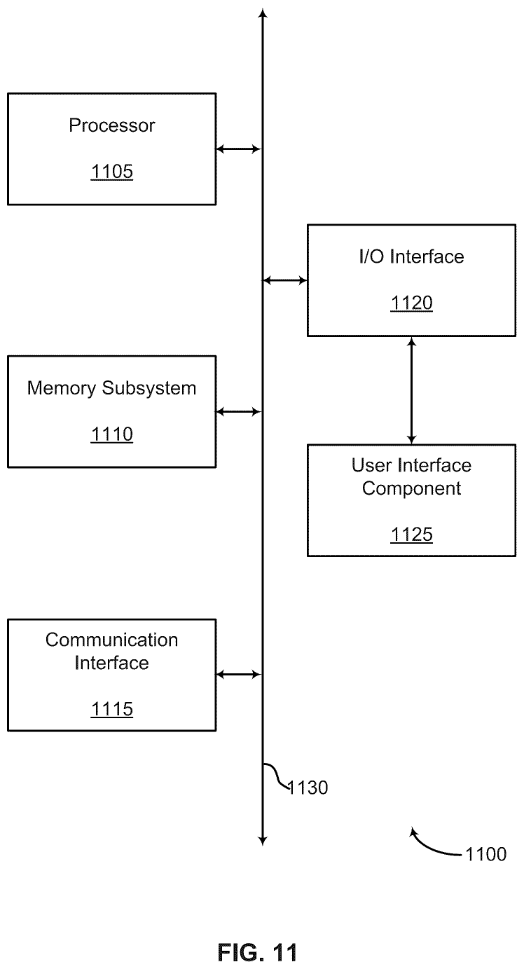

An example system of the inventive concept in image processing is provided with reference to FIGS. 1 and 11. An example application of the inventive concept in image processing is provided with reference to FIGS. 2-3. Details regarding the architecture of an image processing apparatus are provided with reference to FIGS. 5-8. An example of a process for image processing is provided with reference to FIGS. 4 and 9. A description of an example training process is provided with reference to FIG. 10.

Embodiments of the present disclosure provide a system and a method that improve on conventional image generation models by accurately generating a synthetic image depicting a person with a facial expression. For example, an expression component is trained to generate a guidance feature based on a FACS representation of the facial expression. By using the FACS representation, an image generation model is able to generate a synthetic image depicting facial expressions without interference from the identity of the input image. By conditioning the image generation model based on an identity code, the image generation model can generate a synthetic image depicting a person different from the person in the input image while maintaining the facial expression indicated by the FACS representation.

### Facial Image Generation

In FIGS. 1-4, and 9, a method, apparatus, non-transitory computer readable medium, and system for image processing are described. One or more aspects of the method, apparatus, non-transitory computer readable medium, and system include obtaining an expression input indicating a facial expression, generating a guidance feature based on the expression input, where the guidance feature includes a facial action coding system (FACS) representation of the facial expression, and generating, using an image generation model, a synthetic image based on the guidance feature, where the synthetic image depicts a face with the facial expression.

In some aspects, the expression input includes a parameter indicating the level of the facial expression. In some aspects, the expression input includes an image of an input face having the facial expression. In some aspects, the expression input includes an extended reality (XR) representation of the facial expression. In some aspects, the expression input includes a natural language description of the facial expression.

Some examples of the method, apparatus, non-transitory computer readable medium, and system further include obtaining a style input describing an attribute of the face, where the synthetic image is generated based on the style input. Some examples of the method, apparatus, non-transitory computer readable medium, and system further include obtaining a spatial orientation input depicting a spatial orientation, where the synthetic image is generated based on the spatial orientation input.

Some examples of the method, apparatus, non-transitory computer readable medium, and system further include obtaining a random input, where the synthetic image is generated based on the random input. In some aspects, the guidance feature indicates a facial muscle activation. In some aspects, the image generation model is trained using training data including FACS representation data.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 5.

Referring to FIG. 1, user 100 provides an input image to image processing apparatus 110 via user device 105 and cloud 115. In some cases, the input image depicts the face of a person having an expression. For example, the input image depicts a man with an open jaw. In some embodiments, image processing apparatus 110 includes a machine learning model enabling user 100 to modify the expression via a parameter control element (e.g., a slider bar). For example, the expression is encoded into FACS action units. In some cases, user 100 may provide additional inputs such as an identity code to change the identity of the person to be generated in a synthetic image. In some embodiments, the machine learning model generates a synthetic image depicting the face of a different person having the same facial expression as depicted in the input image. For example, the synthetic image depicts a woman with an open jaw.

In some embodiments, image processing apparatus receives a video (or a plurality of images) depicting the man having one or more facial expressions to generate an output video depicting a different person having the same facial expressions. In some embodiments, a facial expression with the input image can be modified based on the parameter control element. For example, the machine learning model encodes a set of pre-determined facial expressions into action units. In some cases, the action units are incorporated into the parameter control element (e.g., a slider bar). Accordingly, by adjusting the parameter control element, the facial expression of the person depicted in the synthetic image can be modified. Image processing apparatus 110 displays the synthetic image to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 5. According to some aspects, image processing apparatus 110 includes a computer implemented network comprising a machine learning model, an expression component, a style component, an orientation component, and an image generation model. Image processing apparatus 110 further includes a processor unit, a memory unit, an I/O module, a user interface, and a training component. In some embodiments, image processing apparatus 110 further includes a communication interface, user interface components, and a bus as described with reference to FIG. 11. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including a ground-truth image having a facial expression and a facial action coding system (FACS) representation of the facial expression. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In some cases, the database controller may operate automatically without user interaction.

FIG. 2 shows an example of a method 200 for facial generation with expression editing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 2, a user (e.g., the user described with reference to FIG. 1) provides a face identifying input and an expression input to the image processing apparatus (e.g., the image processing apparatus described with reference to FIGS. 1 and 5). The face identifying input can be an image or a text that describes an image to be generated. An input image can depict an identity of a person, or an input text can provide an instruction to generate a synthetic identity. The expression input can include an image of an expression, a category of an expression, text describing an expression, a parameter indicating a level of an expression, or any combination thereof. In some cases, an identity of a user and a type of expression can be extracted from the same input image and another input (such as a slider input) can be used to adjust the expression (e.g., “increase the smile on the face).

For example, an expression input could include an image that depicts a man with an open jaw expression. In another example, the user may provide an input such as a Facial Action Coding System (FACS) parameter or an identity code. The FACS parameter represents an anatomically feasible facial expression. For example, the identity code includes the identity of a person or an animated character. In some embodiments, a machine learning model removes the identity of the person depicted in the input image. Then, a second identity, different from the identity of the person depicted in the input image, is received via the identity code. In some embodiments, the expression of the person to be generated in a synthetic image can be modified via the FACS parameter. In one aspect, an image generation model is configured to generate the synthetic image based on the input image, the FACS parameter, and the identity code.

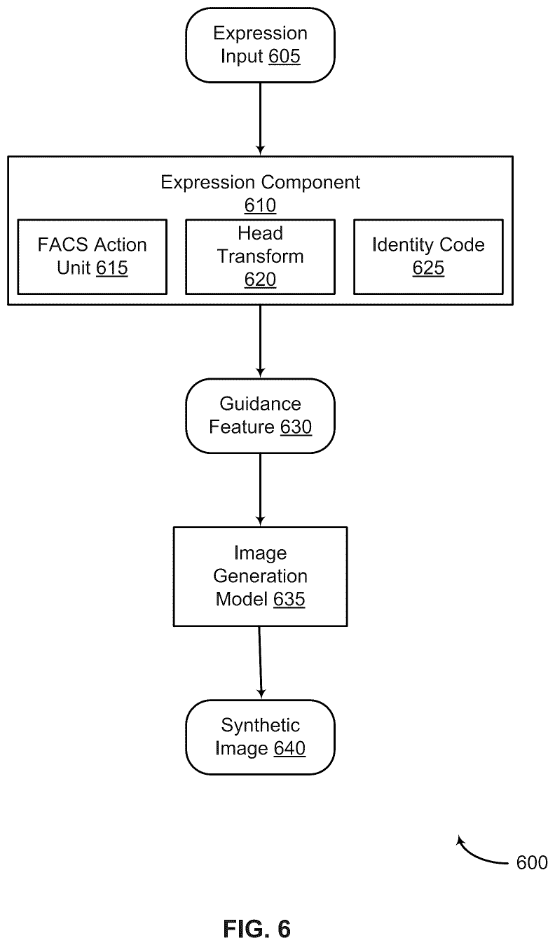

At operation 205, a user provides the face identifying input and the expression input as described above. In some cases, the operations of this step refer to, or may be performed by, a user as described with reference to FIG. 1. In some cases, for example, the expression input comprises an image that depicts a man with an open jaw expression. In some cases, a parameter control includes one or more slider bars that enable a user to modify or adjust an expression of the person depicted in the synthetic image. For example, a slider bar may control the movement of the eyebrow. For example, a slider bar may control the movement of the lip. For example, a slider bar may control the movement of the cheek. Further detail on the FACS parameter is described with reference to FIGS. 3 and 6.

In some cases, an input image will depict a face, and the system will generate a modified image of the same face from the input image. Alternatively, the system can apply the target expression to another face. For example, a text prompt can be provided that describes a target face, and a synthetic face can be generated based on the text prompt with the target expression.

At operation 210, the system encodes the FACS parameter into an action unit. In some cases, the operations of this step refer to, or may be performed by, an image processing apparatus as described with reference to FIGS. 1 and 5. In some cases, a machine learning model encodes a set of anatomically feasible facial expressions into action units (AUs). An action unit represents a movement of the facial muscle. In some cases, one or more action units may be combined to generate emotion-related expressions. For example, AU6 (cheek raiser) and AU12 (Lip corner puller) may be combined to indicate a natural facial expression that represents happiness. Further detail on action units is described with reference to FIGS. 3 and 6.

At operation 215, the system generates a guidance feature based on the input image and the action unit. In some cases, the operations of this step refer to, or may be performed by, an image processing apparatus as described with reference to FIGS. 1 and 5. In some cases, the operations of this step refer to, or may be performed by, an expression component as described with reference to FIGS. 5 and 6. In some cases, for example, an expression component receives the input image and the action unit to generate a guidance feature to guide the image generation process of the image generation model. For example, the guidance feature includes information about a facial expression to be generated in the synthetic image. By guiding the image generation process using the guidance feature, the image generation model can generate a synthetic image depicting a facial expression of a person substantially the same as the facial expression indicated by the action unit. In some cases, the guidance feature may be a vector, a multi-dimensional array, or a combination thereof. In some cases, the guidance feature may be in a vector space, an image space, or a multi-modal space. For example, the multi-modal space is a shared representation where different types of data such as text, image, audio, and/or video are mapped to be jointly processed.

At operation 220, the system generates a synthetic image based on the guidance feature. In some cases, the operations of this step refer to, or may be performed by, an image processing apparatus as described with reference to FIGS. 1 and 5. In some cases, the operations of this step refer to, or may be performed by, an image generation model as described with reference to FIGS. 5 and 6. In some cases, for example, the image generation model generates a synthetic image depicting the face of a different person having the same facial expression as the input image. For example, the synthetic image depicts a woman with an open jaw expression. In some cases, the synthetic image may depict the face of a different person having a different facial expression from the input image based on the FACS parameter. In some cases, the synthetic image is displayed to the user via a user interface provided by the image processing apparatus on the user device.

FIG. 3 shows an example of a user interface 300 for facial generation according to aspects of the present disclosure. The example shown includes user interface 300, interface canvas 305, parameter control panel 310, input image 315, 3D model 320, and synthetic image 325.

Referring to FIG. 3, user interface 300 may include interface canvas 305. For example, interface canvas 305 is a space within an application (or user interface 300) that enables a user to interact with the graphical contents. In some cases, parameter control panel 310, input image 315, 3D model 320, and synthetic image 325 are displayed within the region of interface canvas 305.

In some embodiments, user interface 300 receives an input image 315 from a user. In some cases, for example, input image 315 may be provided by a separate apparatus or a separate computing device. For example, input image 315 may be an image generated using Google® Mediapipe. For example, input image 315 may be an extended reality representation generated using Apple® ARKit. In some cases, for example, input image 315 may be generated from a natural language description or audio description. In an embodiment, user interface 300 may generate input image 315 by taking a photo of the user. For example, the input image 315 depicts a man with an open jaw expression.

In some embodiments, user interface 300 includes a parameter control panel 310 for controlling and modifying the facial expression of the person depicted in synthetic image 325. For example, parameter control panel 310 may include a set of slider bars for adjusting one or more facial muscles (or the facial expression) in 3D model 320 and/or synthetic image 325. For example, a slider bar may be used to control the jaw movement. For example, a slider bar may be used to control the eyebrow movement. In some cases, parameter control panel 310 includes a control element to import input image 315 (from a separate device or from user interface 300). In some cases, user interface includes a facial action coding system (FACS). In some cases, action units (AUs) generated from FACS are incorporated into parameter control panel 310. In some cases, parameter control panel 310 controls or adjusts the facial muscles or facial expressions using encoded FACS AUs. In some cases, parameter control panel 310 includes parameterization for intuitive editing (e.g., high-level expressions such as “happy”). In some cases, the parameters are mapped or encoded in FACS AUs such as mapping the high-level facial expression “happy” to an individual or a combination of FACS AUs including “lip corner pull” and “cheek raiser”. Further detail on FACS AUs is described with reference to the Action Unit Table in FIG. 6.

In some embodiments, user interface 300 includes 3D model 320. For example, 3D model 320 represents the human head depicted in input image 315. In some cases, 3D model 320 follows the facial expression depicted in input image 315. For example, 3D model 320 and input image 315 have an expression of open jaw. In some aspects, 3D model 320 is a 3×4 matrix representing the 3D rigid transformation (rotation and translation) of the human head depicted in input image 315. In one embodiment, the scale of 3D model 320 is normalized, where the human head in 3D model 320 is normalized to a predetermined size regardless of the size of the human head depicted in input image 315. In some cases, the information from 3D model 320 is used to infer the placement and the face direction of the human head in input image 315.

In some embodiments, user interface 300 generates a synthetic image 325 based on the input image 315. In some cases, for example, synthetic image 325 may depict a different person having the same facial expression from input image 315. For example, synthetic image 325 on the top of interface canvas 305 may depict a woman with the same open jaw expression. For example, synthetic image 325 on the bottom of interface canvas 305 may depict a man (different from the man depicted in the input image 315) with the same open jaw expression. In some embodiments, synthetic image 325 may depict a different person having a different facial expression from input image 315.

User interface 300 is an example of, or includes aspects of, the corresponding element described with reference to FIG. 5. Synthetic image 325 is an example of, or includes aspects of, the corresponding element described with reference to FIG. 6.

FIG. 4 shows an example of a method 400 for generating a synthetic image based on an expression input according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 405, the system obtains an expression input indicating a facial expression. In some cases, the operations of this step refer to, or may be performed by, an expression component as described with reference to FIGS. 5 and 6. In some cases, for example, the expression input may be an input image depicting the face of a person with a facial expression or an extended reality representation of a person having the facial expression. For example, the extended reality representation may include an animated character of the person.

In other examples cases, the expression input may be a natural language description or an audio description of the expression. In some cases, a synthetic image may be generated based on the input description and the synthetic image may be used as the expression input. Further detail on expression input is described with reference to FIG. 9.

The system applies the target expression to a face that can either come from an input image, or it can be generated synthetically (e.g., based on a text prompt). In some cases the expression input includes information about both the expression and the identity of the face and in other cases the inputs can be separate. For example, in some cases the expression input includes an image of a face with an initial expression along with a parameter for adjusting the expression, and the system will generate a modified image of the same face from the input image with the adjusted expression. Alternatively, the system can apply the target expression to another face. For example, a text prompt can be provided that describes a target face, and a synthetic face can be generated based on the text prompt with the target expression.

At operation 410, the system generates a guidance feature based on the expression input, where the guidance feature includes a facial action coding system (FACS) representation of the facial expression. In some cases, the operations of this step refer to, or may be performed by, an expression component as described with reference to FIGS. 5 and 6. In some cases, the guidance feature may be a guidance embedding (a vector or multi-dimensional array) used to guide the image generation process. For example, the guidance feature may include an image embedding of the input image. For example, the guidance feature may include an embedding of the action units generated from the facial action coding system (FACS). In one aspect, FACS breaks down facial expressions into individual components as action units (AUs). Each AU corresponds to a specific muscle or group of muscles representing the facial expression and the emotions. In some cases, AUs are used to analyze and replicate human facial expressions. In some cases, the information from AUs is used to condition the image generation process of the image generation model. Further detail on FACS is described with reference to FIG. 6.

At operation 415, the system generates, using an image generation model, a synthetic image based on the guidance feature, where the synthetic image depicts a face with the facial expression. In some cases, the operations of this step refer to, or may be performed by, an image generation model as described with reference to FIGS. 5 and 6. In some cases, for example, the synthetic image depicts a person different from the person in the input image. In some cases, the synthetic image depicts an animated character representing the person having the same facial expression. When the input image depicts a face, the synthetic image can depict the same face with the target facial expression. When the expression input is a text description, the synthetic image can depict a synthesized face with the target expression.

### System Architecture

In FIGS. 5-8, and 11, an apparatus and system for image processing are described. One or more aspects of the apparatus and system include at least one processor; at least one memory storing instructions executable by the at least one processor; an expression component comprising parameters stored in the at least one memory and configured to generate a guidance feature based on an expression input indicating a facial expression, where the guidance feature includes a facial action coding system (FACS) representation of the facial expression; and an image generation model comprising parameters stored in the at least one memory and trained to generate a synthetic image based on the guidance feature, where the synthetic image depicts a face with the facial expression.

Some examples of the apparatus and system further include a style component configured to obtain a style input describing an attribute of the face, where the synthetic image is generated based on the style input. Some examples of the apparatus and system further include an orientation component configured to obtain a spatial orientation input depicting a spatial orientation, where the synthetic image is generated based on the spatial orientation input.

In some embodiments, the image generation model includes a Co-Modulated Generative Adversarial Network (CoModGAN). In some aspects, the image generation model includes a diffusion model. Some examples of the apparatus and system further include a user interface configured to receive the expression input indicating a level of the facial expression.

FIG. 5 shows an example of an image processing apparatus 500 according to aspects of the present disclosure. The example shown includes image processing apparatus 500, processor unit 505, I/O module 510, memory unit 515, user interface 540, and training component 545. In one aspect, memory unit 515 includes expression component 520, style component 525, orientation component 530, and image generation model 535.

According to some embodiments of the present disclosure, image processing apparatus 500 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes include real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 500 is an example of, or includes aspects of, the corresponding element described with reference to FIG. 1.

Processor unit 505 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 505 is configured to operate a memory array using a memory controller. In other cases, a memory controller is integrated into the processor. In some cases, processor unit 505 is configured to execute computer-readable instructions stored in a memory to perform various functions. In some embodiments, processor unit 505 includes special-purpose components for modem processing, baseband processing, digital signal processing, or transmission processing. Processor unit 505 is an example of, or includes aspects of, the processor described with reference to FIG. 11.

I/O module 510 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 510 includes a user interface. A user interface may enable a user to interact with a device. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 510 is an example of, or includes aspects of, the I/O interface described with reference to FIG. 11.

Examples of memory unit 515 include random access memory (RAM), read-only memory (ROM), or a hard disk. Examples of memory unit 515 include solid-state memory and a hard disk drive. In some examples, memory unit 515 is used to store computer-readable, computer-executable software including instructions that, when executed, cause a processor to perform various functions described herein.

In some cases, memory unit 515 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 515 store information in the form of a logical state.

In one aspect, memory unit 515 includes expression component 520, style component 525, orientation component 530, and image generation model 535. In one aspect, memory unit 515 includes a machine learning model, where the machine learning model includes expression component 520, style component 525, orientation component 530, and image generation model 535. Memory unit 515 is an example of, or includes aspects of, the memory subsystem described with reference to FIG. 11.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 515 and executable by processor unit 505, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes include real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that enables the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules include multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence), and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, which enables an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model in which representations of the input interact with each other to determine attention weights for the input. Self-attention can be distinguished from other attention models because the attention weights are determined at least in part by the input.

According to some aspects, expression component 520 is implemented as software stored in memory unit 515 and executable by processor unit 505, as firmware, as one or more hardware circuits, or as a combination thereof. In some aspects, expression component 520 obtains an expression input indicating a facial expression. In some examples, expression component 520 generates a guidance feature based on the expression input, where the guidance feature includes a facial action coding system (FACS) representation of the facial expression.

In some aspects, the expression input includes a parameter indicating the level of the facial expression. In some aspects, the expression input includes an image of an input face having the facial expression. In some aspects, the expression input includes an extended reality (XR) representation of the facial expression. In some aspects, the expression input includes a natural language description of the facial expression. In some aspects, the guidance feature indicates a facial muscle activation.

According to some aspects, expression component 520 comprises parameters stored in the at least one memory and configured to generate a guidance feature based on an expression input indicating a facial expression, where the guidance feature includes a facial action coding system (FACS) representation of the facial expression. Expression component 520 is an example of, or includes aspects of, the corresponding element described with reference to FIG. 6.

According to some aspects, style component 525 is implemented as software stored in memory unit 515 and executable by processor unit 505, as firmware, as one or more hardware circuits, or as a combination thereof. According to some aspects, style component 525 obtains a style input describing an attribute of the face, where the synthetic image is generated based on the style input. According to some aspects, style component 525 is configured to obtain a style input describing an attribute of the face, where the synthetic image is generated based on the style input.

According to some aspects, orientation component 530 is implemented as software stored in memory unit 515 and executable by processor unit 505, as firmware, as one or more hardware circuits, or as a combination thereof. According to some aspects, orientation component 530 obtains a spatial orientation input depicting a spatial orientation, where the synthetic image is generated based on the spatial orientation input. According to some aspects, orientation component 530 is configured to obtain a spatial orientation input depicting a spatial orientation, where the synthetic image is generated based on the spatial orientation input.

According to some aspects, image generation model 535 is implemented as software stored in memory unit 515 and executable by processor unit 505, as firmware, as one or more hardware circuits, or as a combination thereof. According to some aspects, image generation model 535 generates a synthetic image based on the guidance feature, where the synthetic image depicts a face with the facial expression.

In some examples, image generation model 535 obtains a random input, where the synthetic image is generated based on the random input. In some aspects, the image generation model 535 is trained using training data including FACS representation data.

According to some aspects, image generation model 535 comprises parameters stored in the at least one memory and trained to generate a synthetic image based on the guidance feature, where the synthetic image depicts a face with the facial expression. In some aspects, the image generation model 535 includes a Co-Modulated Generative Adversarial Network (CoModGAN). In some aspects, the image generation model 535 includes a diffusion model.

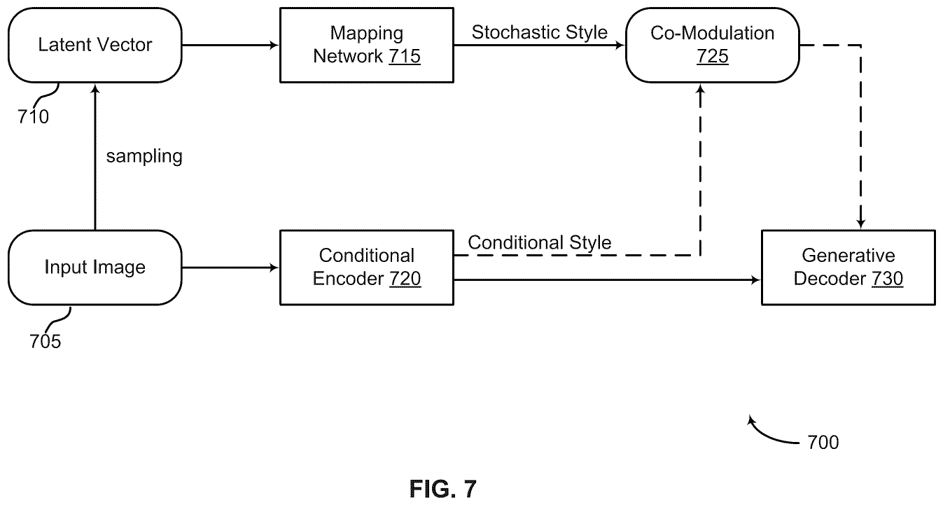

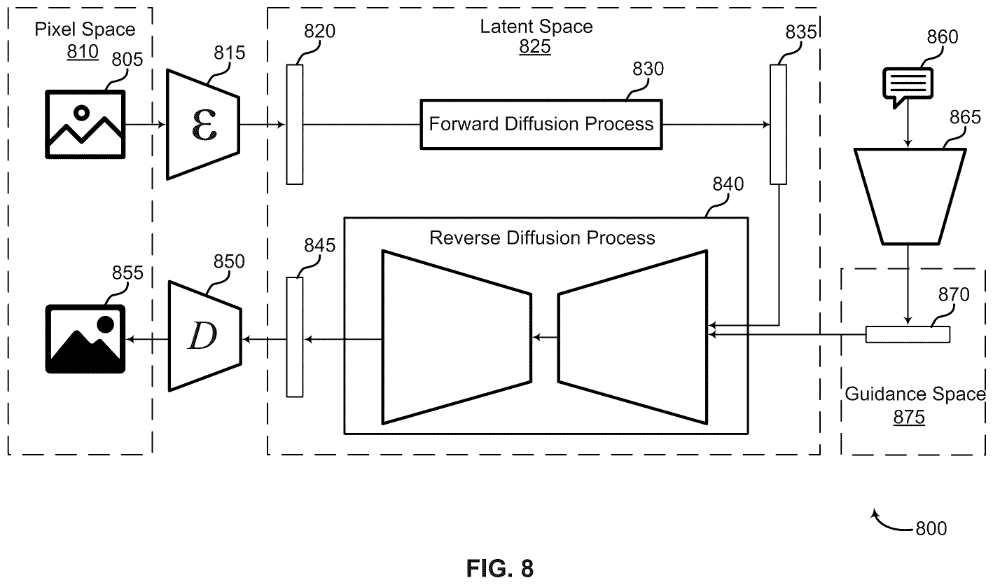

Image generation model 535 is an example of, or includes aspects of, the corresponding element described with reference to FIG. 6. Image generation model 535 is an example of, or includes aspects of, the CoModGAN described with reference to FIG. 7. Image generation model 535 is an example of, or includes aspects of, the diffusion model described with reference to FIG. 8.

According to some aspects, user interface 540 is configured to receive the expression input indicating a level of the facial expression. User interface 540 is an example of, or includes aspects of, the corresponding element described with reference to FIG. 3. User interface 540 is an example of, or includes aspects of, the user interface component described with reference to FIG. 11.

According to some aspects, training component 545 is implemented as software stored in memory unit 515 and executable by processor unit 505, as firmware, as one or more hardware circuits, or as a combination thereof. According to some embodiments, training component 545 is implemented as software stored in a memory unit and executable by a processor in the processor unit of a separate computing device, as firmware in the separate computing device, as one or more hardware circuits of the separate computing device, or as a combination thereof. In some examples, training component 545 is part of another apparatus other than image processing apparatus 500 and communicates with the image processing apparatus 500. In some examples, training component 545 is part of image processing apparatus 500.

According to some aspects, training component 545 obtains training data including a ground-truth image having a facial expression and a facial action coding system (FACS) representation of the facial expression. In some examples, training component 545 trains, using the training data, an image generation model 535 to generate a synthetic image depicting a face having the facial expression based on the FACS representation.

In some examples, training component 545 computes a facial expression loss. In some examples, training component 545 updates parameters of the image generation model 535 based on the facial expression loss. In some examples, training component 545 computes a diffusion loss. In some examples, training component 545 updates parameters of the image generation model 535 based on the diffusion loss. In some examples, training component 545 computes a generative adversarial network (GAN) loss. In some examples, training component 545 updates parameters of the image generation model 535 based on the GAN loss.

FIG. 6 shows an example of a machine learning model according to aspects of the present disclosure. The example shown includes machine learning system 600, expression input 605, expression component 610, guidance feature 630, image generation model 635, and synthetic image 640. In one aspect, expression component 610 includes FACS action unit 615, head transform 620, and identity code 625. In one aspect, machine learning system 600 includes expression component 610 and image generation model 635.

Referring to FIG. 6, the machine learning system 600 receives expression input 605 to generate synthetic image 640. For example, expression component 610 receives expression input 605 to generate guidance feature 630. In some cases, expression input 605 depicts a facial expression. In some embodiments, expression input 605 includes an image of an input face, a parameter indicating a level of the facial expression, an extended reality (XR) representation, or a natural language description. Further detail on expression input 605 is described with reference to FIG. 9.

In some embodiments, expression component 610 includes FACS action unit 615, head transform 620, and identity code 625. For example, FACS action unit 615 may be generated from FACS (facial action coding system). FACS is a model that classifies human facial movements based on the visual appearance of the huma face. For example, FACS encodes anatomically feasible facial expressions into one or more action units (AUs). In some cases, an AU includes information and representation of a muscle movement or a facial expression. For example, the muscle movement includes contractions or relaxations of one or more facial muscles. In some cases, an AU can be used for higher-order decision-making processing including recognition of basic emotions. In some cases, the AUs may be determined as shown in the Action Unit Table below:

Action Unit Table

| AU Number | FACS Name |
|---|---|
| AU1 | Inner brow raiser |
| AU2 | Outer brow raiser |
| AU4 | Brow lowerer |
| AU5 | Upper lid raiser |
| AU6 | Cheek raiser |
| AU7 | Lid tightener |
| AU8 | Lips toward |
| AU9 | Nose wrinklet |
| AU10 | Upper lip raiser |
| AU11 | Nasolabial deepener |
| AU12 | Lip comer puller |
| AU13 | Sharp lip puller |
| AU14 | Dimpler |
| AU15 | Lip corner depressor |
| AU16 | Lower lip depressor |
| AU17 | Chin raiser |
| AU18 | Lip pucker |
| AU19 | Tongue show |
| AU20 | Lip stretcher |
| AU21 | Neck tightener |
| AU22 | Lip funneler |
| AU23 | Lip tightener |
| AU24 | Lip pressor |
| AU25 | Lips part |
| AU26 | Jaw drop |
| AU27 | Mouth stretch |
| AU28 | Lip suck |
| AU29 | Jaw thrust |
| AU30 | Jaw sideways |
| AU31 | Jaw clencher |
| AU32 | Lip bite |
| AU33 | Cheek blow |
| AU34 | Cheek puff |
| AU35 | Cheek suck |
| AU36 | Tongue bulge |
| AU37 | Lip wipe |
| AU38 | Nostril dilator |
| AU39 | Nostril compressor |
| AU40 | Sniff |
| AU41 | Lid droop |
| AU42 | Slit |
| AU43 | Eyes closed |
| AU44 | Squint |
| AU45 | Blink |
| AU46 | Wink |
| AU50 | Speech |

In some embodiments, one or more AUs are used to determine an emotion of the person depicted in an input image. For example, happiness is represented using AU6 and AU12. For example, sadness is represented using AU1, AU4, and AU15. For example, anger is represented using AU4, AU5, AU7, and AU23. Other emotions can be determined and represented using the Action Unit Table. In addition, the AUs described in the Action Unit Table are merely examples and are not necessarily limited thereto.

In some embodiments, expression component 610 detects the facial expression from expression input 605 and determines an AU based on the visual appearance of the facial muscle. For example, expression component 610 encodes expression input 605 in FACS action unit 615. In some cases, an AU is provided to expression component 610 by a user to adjust and modify the facial expression. In some cases, an AU is a subject-agnostic feature vector representing the general human expression.

In some embodiments, expression component 610 includes head transform 620. For example, head transform 620 is a 3D model that represents the human head from an input image. In some cases, the head transform is a 3×4 matrix representing the 3D rigid transformation (rotation and translation) of the human head depicted in the input image. In one embodiment, the scale of the 3D model is normalized, where the human head in the 3D model is normalized to a predetermined size regardless of the size of the human head depicted in the input image. In some cases, the information from the 3D model is used to infer the placement and the face direction of the human head in the input image.

In some embodiments, expression component 610 includes identity code 625. For example, identity code 625 includes an identity of a person or an animated character. In some embodiments, a machine learning model removes the identity of the person depicted in the input image. Then, a second identity, different from the identity of the person depicted in the input image, is received via the identity code. In some cases, identity code 625 includes a subject-specific feature that represents how a person looks.

In some embodiments, expression component 610 generates guidance feature 630 based on expression input 605, FACS action unit 615, head transform 620, or identity code 625. For example, expression input 605 includes an input image depicting a person having an initial facial expression. For example, FACS action unit 615 controls the facial expression via AUs. For example, head transform 620 controls the movement (e.g., linear or rotational movement) of the human head. For example, identity code 625 controls the identity of the person to be generated in synthetic image 640. In one aspect, guidance feature 630 is used to guide the image generation process. Further detail on guiding the image generation process is described with reference to FIGS. 7 and 8.

Image generation model 635 receives guidance feature 630 to generate synthetic image 640. In some cases, image generation model 635 includes a CoModGAN described with reference to FIG. 7. In some cases, image generation model 635 includes a diffusion model described with reference to FIG. 8. In some cases, the image generation process of image generation model 635 is guided based on guidance feature 630, and therefore, image generation model 635 is able to generate controlled and semantically meaningful images. In one aspect, synthetic image 640 includes contents of facial expression represented by FACS action unit 615 and an identity represented by identity code 625.

Expression component 610 is an example of, or includes aspects of, the corresponding element described with reference to FIG. 5. Guidance feature 630 is an example of, or includes aspects of, the corresponding element described with reference to FIG. 8. Image generation model 635 is an example of, or includes aspects of, the corresponding element described with reference to FIG. 5. Synthetic image 640 is an example of, or includes aspects of, the corresponding element described with reference to FIG. 3.

FIG. 7 shows an example of a Co-Modulated Generative Adversarial Network (CoModGAN) according to aspects of the present disclosure. The example shown includes CoModGAN 700, input image 705, latent vector 710, mapping network 715, conditional encoder 720, co-modulation 725, and generative decoder 730. CoModGAN 700 is an example of, or includes aspects of, the image generation model described with reference to FIGS. 5 and 6.

CoModGAN 700 generates diverse and consistent content not only for small-scale image generation but also for large-scale image completion by embedding conditional and stochastic style representations. Conditional style representation is a type of learned styled representation embedded from a conditional input to enhance output. Stochastic style representation is used for large-scale image completion and is able to produce diverse results even when both the input image and input mask are fixed.

Referring to FIG. 7, input image 705 is sampled into latent vector 710. Mapping network 715 receives latent vector 710 and a stochastic style is applied to the output feature of mapping network 715. In some aspects, conditional encoder 720 encodes the input image 705 and a conditional style is applied to the output feature of conditional encoder 720. Input image 705 is an example of, or includes aspects of, the corresponding element described with reference to FIG. 3.

Co-modulation 725 is applied to the output feature of mapping network 715 and the output feature of conditional encoder 720. The output from co-modulation 725 is input to generative decoder 730. In some cases, the image generation model applies co-modulation 725 for large-scale image completion. Accordingly, results from the co-modulation 725 and the output feature of conditional encoder 720 are received as inputs to generative decoder 730. In some cases, the image generation model does not apply co-modulation 725 for small-scale image generation, and the output feature of conditional encoder 720 is taken as the input to generative decoder 730.

An extension of CoModGAN 700 is Guided CoModGAN. Guide CoModGAN takes a “guide” vector along with the input image 705. Guided CoModGAN controls the content generation by extracting a guide from the guidance vector to guide the image generation process. In some cases, the Guided CoModGAN is used for face anonymization or facial image generation. For example, the Guided CoModGAN may generate an image having content consistent with the guidance vector. In some cases, the guidance vector may be the same as the guidance feature described according to the present disclosure.

FIG. 8 shows an example of an image generation model according to aspects of the present disclosure. The example shown includes diffusion model 800, original image 805, pixel space 810, image encoder 815, original image feature 820, latent space 825, forward diffusion process 830, noisy feature 835, reverse diffusion process 840, denoised image feature 845, image decoder 850, output image 855, text prompt 860, text encoder 865, guidance feature 870, and guidance space 875. Guidance feature 870 is an example of, or includes aspects of, the corresponding element described with reference to FIG. 6.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 800 may take an original image 805 in a pixel space 810 as input and apply an image encoder 815 to convert original image 805 into original image feature 820 in a latent space 825. Then, a forward diffusion process 830 gradually adds noise to the original image feature 820 to obtain noisy feature 835 (also in latent space 825) at various noise levels.

Next, a reverse diffusion process 840 (e.g., a U-Net ANN) gradually removes the noise from the noisy feature 835 at the various noise levels to obtain the denoised image feature 845 in latent space 825. In some examples, denoised image feature 845 is compared to the original image feature 820 at each of the various noise levels, and parameters of the reverse diffusion process 840 of the diffusion model are updated based on the comparison. Finally, an image decoder 850 decodes the denoised image feature 845 to obtain an output image 855 in pixel space 810. In some cases, an output image 855 is created at each of the various noise levels. The output image 855 can be compared to the original image 805 to train the reverse diffusion process 840. In some cases, output image 855 refers to the synthetic image (e.g., described with reference to FIGS. 3 and 6).

In some cases, image encoder 815 and image decoder 850 are pre-trained prior to training the reverse diffusion process 840. In some examples, image encoder 815 and image decoder 850 are trained jointly, or the image encoder 815 and image decoder 850 are fine-tuned jointly with the reverse diffusion process 840.

The reverse diffusion process 840 can also be guided based on a text prompt 860, or another guidance prompt, such as an image, a layout, a style, a color, a segmentation map, etc. The text prompt 860 can be encoded using a text encoder 865 (e.g., a multimodal encoder) to obtain guidance feature 870 in guidance space 875. The guidance feature 870 can be combined with the noisy feature 835 at one or more layers of the reverse diffusion process 840 to ensure that the output image 855 includes content described by the text prompt 860. For example, guidance feature 870 can be combined with the noisy feature 835 using a cross-attention block within the reverse diffusion process 840.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, enabling the machine learning model to understand the context and generate more accurate and contextually relevant outputs.

In some examples, diffusion models are based on a neural network architecture known as a U-Net. The U-Net takes input features having an initial resolution and an initial number of channels and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having the same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 860) describing content to be included in a generated image. In some examples, guidance can be provided in a form other than text, such as via an image, a sketch, a color, a style, or a layout. The system converts text prompt 860 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 800 generates an image based on the noise map and the conditional guidance vector.

A diffusion process can include both a forward diffusion process 830 for adding noise to an image (e.g., original image 805) or features (e.g., original image feature 820) in a latent space 825 and a reverse diffusion process 840 for denoising the images (or features) to obtain a denoised image (e.g., output image 855). The forward diffusion process 830 can be represented as q(xₜ|xₜ₋₁), and the reverse diffusion process 840 can be represented as p(xₜ₋₁|xₜ). In some cases, the forward diffusion process 830 is used during training to generate images with successively greater noise, and a neural network is trained to perform the reverse diffusion process 840 (e.g., to successively remove the noise).

In an example forward diffusion process 830 for a latent diffusion model (e.g., diffusion model 800), the diffusion model 800 maps an observed variable x₀ (either in a pixel space 810 or a latent space 825) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 840. During the reverse diffusion process 840, the diffusion model 800 begins with noisy data x_{T}, such as a noisy image and denoises the data to obtain the p(xₜ₋₁|xₜ). At each step t−1, the reverse diffusion process 840 takes xₜ, such as the first intermediate image, and t as input. Here, t represents a step in the sequence of transitions associated with different noise levels, The reverse diffusion process 840 outputs xₜ₋₁, such as the second intermediate image iteratively until x₇ is reverted back to x₀, the original image 805. The reverse diffusion process 840 can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T};0,l) is the pure noise distribution as the reverse diffusion process 840 takes the outcome of the forward diffusion process 830, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space 825 as input and a generated data \tilde{x} is mapped back into the pixel space 810 from the latent space 825 as output. In some examples, x₀ represents an original input image with low image quality, latent variables x₁, . . . , x_{T} represent noisy images, and \tilde{x} represents the generated image with high image quality.

A diffusion model 800 may be trained using both a forward diffusion process 830 and a reverse diffusion process 840. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 830 in N stages. In some cases, the forward diffusion process 830 is a fixed process where Gaussian noise is successively added to an image. In latent diffusion models, the Gaussian noise may be successively added to features (e.g., original image feature 820) in a latent space 825.

At each stage n, starting with stage N, a reverse diffusion process 840 is used to predict the image or image features at stage n−1. For example, the reverse diffusion process 840 can predict the noise that was added by the forward diffusion process 830, and the predicted noise can be removed from the image to obtain the predicted image. In some cases, an original image 805 is predicted at each stage of the training process.

The training component (e.g., training component described with reference to FIG. 6) compares predicted image (or image features) at stage n−1 to an actual image (or image features), such as the image at stage n−1 or the original input image. For example, given observed data x, the diffusion model 800 may be trained to minimize the variational upper bound of the negative log-likelihood −log p_{θ}(x) of the training data. The training component then updates parameters of the diffusion model 800 based on the comparison. For example, parameters of a U-Net may be updated using gradient descent. Time-dependent parameters of the Gaussian transitions can also be learned.

FIG. 9 shows examples of an expression input according to aspects of the present disclosure. For example, the expression input 900 includes parameter control 905, input image 910, extended reality (XR) representation 915, and natural language description 920. For example, the image generation model (e.g., the image generation model described with reference to FIG. 6) receives one or more of the examples of expression input 900 to generate the synthetic image. For example, the input image 910 depicting a person's face in real-time can be provided to the image generation model to generate the synthetic image. For example, a person's expression can be converted into an animation (e.g., XR representation 915), and the animation can be provided to the image generation model to generate the synthetic image.

In some embodiments, parameter control 905 includes a parameter indicating a level of the facial expression. In some cases, the parameter includes an action unit (AU) generated from the facial action coding system (FACS). For example, each AU may represent a muscle movement, a facial expression, or an emotion. In some cases, one or more AUs may be combined to represent the facial expression or emotion. In some cases, the parameter is incorporated into one or more slider bars. Further detail on AU is described with reference to FIG. 6.

In some embodiments, an input image 910 depicting the facial expression is provided to the machine learning model. In some cases, the input image 910 may be generated from a separate apparatus or device. Then, the input image 910 may be imported into the image generation model of the present disclosure. In some cases, a user interface (e.g., the user interface described with reference to FIG. 3) may generate the input image 910 by capturing a photo (or video) of the user. Further detail on the input image 910 is described with reference to FIG. 3. Input image is an example of, or includes aspects of, the corresponding element described with reference to FIG. 3.

In some embodiments, XR representation 915 depicting the facial expression is provided to the machine learning model. In some cases, the XR representation 915 may include virtual reality (VR) representation, augmented reality (AR) representation, and/or mixed reality (MR) representation. For example, VR representation may include a VR character/entity in a virtual environment. For example, AR representation may include an AR character/entity that overlays in a real-world environment. For example, the MR representation may include an MR character/entity in a blend of physical and digital realities in real-time. In some cases, the XR representation 915 includes an animated character having a facial expression that represents the expression of a person (e.g., a user) in real time. In some cases, XR representation 915 is obtained from a separate apparatus or device.

In some embodiments, a natural language description 920 describing a facial expression is provided to the machine learning model. In some cases, the natural language description 920 may include a text description of the facial expression. For example, the text description may state “a man with a smiling face.” In some cases, a separate image generation model may generate an image based on the text description. In some cases, the machine learning model of the present disclosure receives the generated image as input. In some embodiments, an audio description may be used to generate the image to be input into the machine learning model. In some embodiments, the machine learning model may generate the input image based on the text description or the audio input.

### Training and Evaluation

In FIG. 10, a method, apparatus, non-transitory computer readable medium, and system for image processing are described. One or more aspects of the method, apparatus, non-transitory computer readable medium, and system include obtaining training data including a ground-truth image having a facial expression and a facial action coding system (FACS) representation of the facial expression and training, using the training data, an image generation model to generate a synthetic image depicting a face having the facial expression based on the FACS representation.

Some examples of the method, apparatus, non-transitory computer readable medium, and system further include computing a facial expression loss. Some examples further include updating parameters of the image generation model based on the facial expression loss.

Some examples of the method, apparatus, non-transitory computer readable medium, and system further include computing a diffusion loss. Some examples further include updating parameters of the image generation model based on the diffusion loss.

Some examples of the method, apparatus, non-transitory computer readable medium, and system further include computing a generative adversarial network (GAN) loss. Some examples further include updating parameters of the image generation model based on the GAN loss.

FIG. 10 shows an example of a method 1000 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1005, the system obtains training data including a ground-truth image having a facial expression and a facial action coding system (FACS) representation of the facial expression. In some cases, the operations of this step refer to, or may be performed by, a training component as described with reference to FIG. 5. In some cases, for example, the training data may be stored in a database (e.g., the database described with reference to FIG. 1). For example, the training data may include a training image (e.g., the ground-truth image) depicting a man smiling. In some cases, the training data includes a corresponding FACS representation of the facial expression (e.g., smiling) in the training image. For example, the FACS representation may include one or more action units (AUs). For example, the facial expression “smiling” may correspond to AU6 and AU12. Further Detail on AU is described with reference to FIG. 6.

At operation 1010, the system trains, using the training data, an image generation model to generate a synthetic image depicting a face having the facial expression based on the FACS representation. In some cases, the operations of this step refer to, or may be performed by, a training component as described with reference to FIG. 5. For example, the image generation model is trained to receive a guidance feature based on an input image and a FACS representation to generate the synthetic image. For example, the guidance feature includes information about a facial expression indicated by the FACS representation. In some cases, the synthetic image, generated from the image generation model, depicts the same facial expression indicated by the FACS representation.

In some embodiments, the parameters of the image generation model are updated based on one or more losses. For example, a training component computes a facial expression loss based on the synthetic image and the ground-truth image. In some cases, the facial expression loss indicates the pixel difference between the synthetic image and the ground-truth image. In some embodiments, the facial expression loss may include a cross-entropy loss, a mean squared error (MSE), a perceptual loss, or an adversarial loss.

In some embodiments, the training component computes a diffusion loss based on the synthetic image and the ground-truth image. For example, the diffusion loss is a mean squared error (MSE) measured between the actual noise and the predicted noise at a sampled time t. In some cases, the MSE may be referred to as the L2 loss. In some cases, the diffusion loss includes a mean absolute error (MAE). In some cases, the MAE is referred to as the L1 loss. In some cases, the parameters of the image generation model are updated based on the diffusion loss.

In some embodiments, the training component computes a generative adversarial (GAN) loss based on the synthetic image and the ground-truth image. In some cases, the GAN loss includes a generator loss (minimization) and a discriminator loss (maximization). The generator loss measures how well the generator is able to make the generated samples (the synthetic image) as the real image (or as close as to the ground-truth image). The discriminator loss measures how well the discriminator can distinguish between the real (e.g., ground-truth) image and the generated sample (e.g., the synthetic image). In some cases, the parameters of the image generation model are updated based on the GAN loss.

### Computing Device

FIG. 11 shows an example of a computing device according to aspects of the present disclosure. The example shown includes computing device 1100, processor 1105, memory subsystem 1110, communication interface 1115, I/O interface 1120, user interface component 1125, and channel 1130.

In some embodiments, computing device 1100 is an example of, or includes aspects of, the image processing apparatus described with reference to FIGS. 1 and 5. In some embodiments, computing device 1100 includes processor 1105 that can execute instructions stored in memory subsystem 1110 to obtain an expression input indicating a facial expression, to generate a guidance feature based on the expression input, where the guidance feature comprises a facial action coding system (FACS) representation of the facial expression, and to generate a synthetic image based on the guidance feature, where the synthetic image depicts a face with the facial expression.

According to some embodiments, processor 1105 includes one or more processors. In some cases, processor 1105 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1105 is configured to operate a memory array using a memory controller. In other cases, a memory controller is integrated into processor 1105. In some cases, processor 1105 is configured to execute computer-readable instructions stored in a memory to perform various functions. In some embodiments, processor 1105 includes special-purpose components for modem processing, baseband processing, digital signal processing, or transmission processing. Processor 1105 is an example of, or includes aspects of, the processor unit described with reference to FIG. 5.

According to some embodiments, memory subsystem 1110 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1110 is an example of, or includes aspects of, the memory unit described with reference to FIG. 5.

According to some embodiments, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1115.

According to some embodiments, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or hardware components controlled by the I/O controller.

According to some embodiments, user interface component 1125 enables a user to interact with computing device 1100. In some cases, user interface component 1125 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIG. 3.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a face identifying input and an expression input indicating a facial expression;
generating a guidance feature based on the expression input, wherein the guidance feature comprises a facial action encoding of the facial expression; and
generating, using an image generation model, a synthetic image based on the face identifying input and the guidance feature, wherein the synthetic image depicts a face corresponding to the face identifying input and having the facial expression.

2. The method of claim 1, wherein:
the face identifying input comprises an image of the face or a text prompt describing the face.

3. The method of claim 1, wherein:
the expression input indicates a category of the facial expression and a level of the facial expression.

4. The method of claim 1, wherein:
the expression input comprises an extended reality (XR) representation of the facial expression.

5. The method of claim 1, wherein:
the expression input comprises a natural language description of the facial expression.

6. The method of claim 1, further comprising:
obtaining a style input describing a facial attribute, wherein the synthetic image depicts the facial attribute based on the style input.

7. The method of claim 1, further comprising:
obtaining a spatial orientation input depicting a spatial orientation, wherein the synthetic image is generated based on the spatial orientation input.

8. The method of claim 1, wherein generating the synthetic image comprises:
obtaining a random input, wherein the synthetic image is generated based on the random input.

9. The method of claim 1, wherein:
the guidance feature indicates a facial muscle activation corresponding to a facial action coding system (FACS).

10. The method of claim 1, wherein:
the image generation model is trained using training data including facial action coding system (FACS) representation data.

11. A method of training a machine learning model, comprising:
obtaining training data including a ground-truth image depicting a face with a facial expression and a facial action encoding of the facial expression; and
training, using the training data, an image generation model to generate a synthetic image depicting the facial expression based on the facial action encoding.

12. The method of claim 11, wherein training the image generation model comprises:
computing a facial expression loss; and
updating parameters of the image generation model based on the facial expression loss.

13. The method of claim 11, wherein training the image generation model comprises:
computing a diffusion loss; and
updating parameters of the image generation model based on the diffusion loss.

14. The method of claim 11, wherein training the image generation model comprises:
computing a generative adversarial network (GAN) loss; and
updating parameters of the image generation model based on the GAN loss.

15. An apparatus comprising:
at least one processor;
at least one memory storing instructions executable by the at least one processor;
an expression component comprising parameters stored in the at least one memory and configured to generate a guidance feature based on an expression input indicating a facial expression, wherein the guidance feature comprises a facial action encoding of the facial expression; and
an image generation model comprising parameters stored in the at least one memory and trained to generate a synthetic image based on a face identifying input and the guidance feature, wherein the synthetic image depicts a face based on the face identifying input with the facial expression from the expression input.

16. The apparatus of claim 15, further comprising:
a style component configured to obtain a style input describing a facial, wherein the synthetic image depicts the facial expression based on the style input.

17. The apparatus of claim 15, further comprising:
an orientation component configured to obtain a spatial orientation input depicting a spatial orientation, wherein the synthetic image is generated based on the spatial orientation input.

18. The apparatus of claim 15, wherein:
the image generation model comprises a Co-Modulated Generative Adversarial Network (CoModGAN).

19. The apparatus of claim 15, wherein:
the image generation model comprises a diffusion model.

20. The apparatus of claim 15, further comprising:
a user interface configured to receive the expression input indicating a level of the facial expression.
